(19) United States
(12) Patent Application Publication
(10) Pub. No.: US 2018/0339425 A1
(43) Pub. Date: Nov. 29, 2018

(54) PROCESS FOR PREPARING A WOOD CHIP BOARD

(71) Applicants: SYNBRA TECHNOLOGY B.V., Etten-Leur (NL); SAVIOLA HOLDING S.R.L., Viadana (MN) (IT)

(72) Inventors: Jan NOORDEGRAAF, Etten-Leur (NL); Kenneth van den HOONAARD, Etten-Leur (NL); Josephus Petrus Maria de JONG, Etten-Leur (NL); Nicola NEGRI, Viadana (IT); Alberto BOTTOLI, Viadana (IT); Peter MATTHIJSSEN, Etten-Leur (NL)

(21) Appl. No.: 15/771,524

(22) PCT Filed: Oct. 27, 2016
(86) PCT No.: PCT/EP2016/075906

§ 371 Date: Apr. 27, 2018

(30) Foreign Application Priority Data
Oct. 27, 2015 (NL) 2015667

(51) Int. Cl. B27N 3/02; B27N 3/00; B27N 3/06; B32B 21/08

(52) U.S. Cl. CPC B27N 3/02; B32B 21/08; B27N 3/06; B27N 3/007

(57) ABSTRACT

The present invention relates to a process for preparing a wood chip board comprising drying a cut raw material, classifying the dried material into several portions, gluing at least one of said portions with a resin and compressing the chip material under pressure and heat to form a board. The present invention also relates to a wood chip board and its use.

The present invention relates to a process for preparing a wood chip board comprising drying a cut raw material, classifying the dried material into several portions, gluing at least one of said portions with a resin and compressing the chip material under pressure and heat to form a board. The present invention also relates to a wood chip board and its use.

U.S. Pat. No. 4,285,843 relates to a wood chip board the binder of which is an aminoplast, in which the amount of solid resin binder in the area of the board surfaces is less than about 8% by weight of the absolutely dry calculated chip material in the board surface, and the amount of solid resin binder in the area of the center of the board calculated as a wt. percentage based on the absolutely dry chip material present at the center, is equal to or greater than in the board surfaces. In addition, thus US patent also discloses a process for preparing such a wood chip board, in which the cut raw material is subjected to drying to give a specific moisture content to size classification to provide a fine portion and a coarse portion. Then the fine portion and the coarse portion are independently coated or “glued” with aqueous aminoplast liquors, where after the chip material thus obtained is strewn into layers and compressed under pressure and heated to form a board. The chip board thus obtained has a thickness of 19 mm and a specific weight of 690 kg/m³.

European patent application EP 0 420 831 relates to a process for form-pressing wood fibre panels, wherein, as a wood fibre panel, a panel with a density between 700-900 kg/m³ containing a binding agent which displays thermoplastic properties during heating is selected. Such a panel is preheated so that the wood fibres and the binding agent which binds the wood fibre form a pliable or stretchable composition, wherein this composition is form-pressed via application of an increasing pressure during continuing heat supply, wherein the pressure and the heat supply are interrupted before the elastic limit of the panel-like stretchable composition is attained.

U.S. Pat. No. 4,517,147 relates to a method of forming a panel or the like from a mat of lignocellulosic material and a curable binder, comprising the steps of: compressing the mat between a pair of heated press platens to a first density within an intermediate-density range, injecting steam into both major surfaces of the mat to substantially saturate the mat with steam, passing steam substantially through the mat from one major surface to the other, compressing the mat to a higher density and a lower thickness to consolidate the mat and cure the binder, and opening the platens after curing the binder and removing the so formed panel.

GB904954 relates to a method for improving the fire-resistance of wood chip board produced by gluing wood chips under pressure wherein 30% of the solid content of urea-formaldehyde resin glue is replaced by specific fire-retardant filler.

GB1302540 relates to a laminated insulation board for application to walls or ceilings comprising a layer of foamed thermoplastic synthetic resin, a facing layer of boarding material and a polyolefin or polyvinyl halide sheet which extends beyond the other components of the laminate forming a lap along at least one edge of the board. The layer of polyolefin sheet comprises polyethylene, the layer of polyvinyl halide sheet comprises polyvinyl chloride, the sheet of foamed resin comprises polystyrene and the facing layer of boarding material is plasterboard.

Japanese patent publication JP 2002-254414 relates to a waterproof board wherein a core stuff material for front layer is formed by adding adhesives to a mixed body of wood powder chip or wood piece chip and urethane powder or by adding adhesives to wood material containing urethane powder wherein wood powder chip and the urethane powder are mixed. After successively accumulating the core stuff material for front layer, the central core layer core stuff material and the core stuff material for front layer, they are integrated by pressure molding to obtain a waterproof board.

US patent application US2012/138224 relates to a process for the production of a multilayer lignocellulose material which comprises at least three layers, only the middle layer or at least some of the middle layers comprising a light lignocellulose-containing substance, the components for the individual layers being placed in layers one on top of the other and pressed at a press temperature of from 150° C. to 230° C. and elevated pressure during from 3 to 15 seconds per mm board thickness, and the expanded plastics particles being obtained from expandable plastics particles by expansion and the expanded plastics particles thus obtained being further used without further intermediate steps for the production of the middle layer. Styrene homopolymer and/or styrene copolymer are used as the sole plastics particle component. The average density of multilayer lignocellulose material of the three-layer lignocellulose is in the range from 400 kg/m³ to 500 kg/m³. The binder used for the outer layers is an aminoplast resin. The thickness of the multilayer lignocellulose material is in the range from 0.5 to 100 mm, in particular in the range from 10 to 40 mm.

JPH0631708 relates to a lightweight particle board composed of a mixture of woody chips 5 of 100 pts.wt. and polystyrene foamed particles of 5-30 pts.wt. in the middle layer of a three layer particle board.

In a typical manufacturing process, using fiberboard as an example, a refining station reduces the incoming wood raw material to fiber form. The fiber is then dried and directed to a blending station where the thermosetting resin is added in a controlled manner and from there to a forming station where the fiber-resin mixture is formed into loosely compacted mats. The mats can be formed individually, although more typically the mat is continuously formed atop a moving supporting structure such as an endless belt. After the mat is formed, it must be compacted and the fiber-resin mixture pressed to thickness and final density at the pressing station. A prepressing station is normally employed to initially reduce the mat thickness and density to manageable levels prior to entry into the final pressing station. Typically, individual mats are then loaded into a platen hot press which is then closed and the resin is allowed to cure.

An object of the present invention is to provide a wood chip board which possesses a good strength and mechanical properties, and in which the weight of the wood chip board is considerably reduced compared with previous wood chip boards.

Another object of the present invention is to provide a wood chip board wherein all the individual components are homogeneously distributed resulting in a weight reduction of the wood chip board.

The present invention thus relates to a for preparing a wood chip board comprising drying a cut raw material, classifying the dried material into several portions, gluing at least one of said portions with a resin and compressing the chip material under pressure and heat to form a board, wherein the present process comprises the following steps:

i) providing a first outer layer comprising a mixture of glue and classified, dried wood material;

ii) providing a core layer comprising a mixture of glue, classified, dried wood material and a particle foam polymer beads;

iii) providing a second outer layer comprising a mixture of glue and classified, dried wood material;

iv) forming a composite plate, comprising said first outer layer, said core layer and said second outer layer;

v) compressing said composite plate under pressure and heat to form said wood chip board.

On basis of the above identified process steps one or more of the objects are attained. The present inventors found that the use of a specific core layer material, namely particle foam polymer beads, has resulted in a wood chip board the weight thereof is considerably reduced compared with other wood chip boards without such a core layer material.

According to a preferred embodiment of the present process step v) comprises two individual steps, namely a first compressing step va) wherein said composite plate is compressed at ambient temperature and a pressure in the range of 0.5-0.7 N/mm² (pressure only apply to mat), followed by a second compressing step vb) wherein said composite plate is compressed in a temperature range of 200-250° C. (hot plate press temperature) and a pressure in the range of 1-5 N/mm² (pressure apply only to board).

In a specific embodiment the amount of particle foam polymer beads in the mixture for the core layer is in a range of 3-50% by weight, preferably 5-35% by weight, on basis of the total weight of the mixture for the core layer. In a situation wherein the amount of particle foam polymer beads is less than 3% by weight no significant weight reduction can be obtained. In a situation wherein the amount of particle foam polymer beads is more than 50% by weight the mechanical properties of the final wood chip board obtained after step v) will be deteriorated. In another embodiment the amount of particle foam polymer beads in the mixture for the core layer is in a range of 1-50% by weight, preferably 1-35% by weight, on basis of the total weight of the mixture for the core layer.

In a specific embodiment the wood chip board obtained after step v) is further treated for obtaining a smooth surface layer, such as a sanding treatment.

In order to obtain the wood chip board with a final surface it is preferred that the wood chip board obtained after step v) is provided with a decorative sheet, such as a melamine decorative sheet.

Preferred examples of polymer beads are particle foam polymer beads chosen form the group of polystyrene (PS), polystyrene-(poly(p-fenylene oxide) (PS/PPO), polypropylene (PP), polyethylene (PE), polyethylene terephthalate (PET), polylactic acid (PLA), mixtures of polylactic acid and starch (PLA/starch), poly(butylene adipate-co-terephthalate)-polylactic acid (PLA/PBAT), polylactic acid-polyhydroxyalkanoate (PLA/PHA), starch, polybutylene succinate (PBS) granulates of cellulose acetate butyrate (CAB), and resol, or combinations thereof.

In a preferred embodiment of poly(butylene adipate-co-terephthalate)-polylactic acid (PLA/PBAT) the amount of PBAT is in a range of 5-95 wt. %, preferably 15-85 wt. %, on basis of the total amount of poly(butylene adipate-co-terephthalate)-polylactic acid (PLA/PBAT).

A preferred example of polylactic acid (PLA) is a copolymer of PLA and another biobased monomer, such as polyethylene glycol (PEG), poly (lactic-co-glycolic acid) (PLGA) and poly (ϵ-caprolactone) (PCL). Such copolymer is preferably chosen from the group of poly(d,l-lactide) with poly(ethylene glycol) with hydroxyl end, poly(d,l-lactide) with poly(ethylene glycol) with carboxylic acid end, poly(d,l-lactide) with poly(ethylene glycol) with maleimide end, poly(d,l-lactide) with poly(ethylene glycol) with amine end, poly(lactide/glycolide) with poly(ethylene glycol) with —COOH end, poly(lactide/glycolide) with poly(ethylene glycol) with maleimide end and poly(lactide/glycolide) with poly(ethylene glycol) with amine end.

In order to obtain a good balance between weight reduction and strength of the final wood chip board polymer beads having a density in a range of 5-250 kg/m³, preferably 10-100 kg/m³, more preferably 20-40 kg/m³ are used.

According to another embodiment of the present process for preparing a wood chip board step ii) is carried out in such a way that polymer beads of the type unexpanded polymer beads loaded with a blowing agent are used. As an example of a blowing agent CO₂ is used. The use of such unexpanded beads loaded with CO₂ in the core layer means that the heat applied during the compressing stage is effectively used to expand the beads in the hot press stage.

Polymer beads having a particle size chosen in a range of the group 2.0-1.6 mm, 1.0-1.6 mm, 0.7-1.0 mm or 0.7-0.4 mm, or a combination thereof are preferably used. In an embodiment the 1.0-1.6 mm range is preferred. In another embodiment the application of a dual range of particle sizes is preferred.

The present invention furthermore relates to a wood chip board provided with a core layer based on particle polymer beads, wherein the density of the core layer is preferably 660-500 kg/m3, more preferably 600-550 kg/m³, even more preferably 570-580 kg/m³.

The present invention furthermore relates to a process for preparing a wood chip board comprising drying a cut raw material, classifying the dried material into several portions, gluing at least one of said portions with a resin and compressing the chip material under pressure and heat to form a board, wherein the amount of particle foam polymer beads based on polylactic acid (PLA) in the mixture for the core layer is in a range of 1-8 wt. %, preferably in a range of 2-6 wt. %, more preferably in a range of 3-5 wt. %, on basis of the total weight of the mixture for the core layer.

The present invention furthermore relates to use of a wood chip board in construction panels, furniture, kitchen cupboards, tables and/or composites.

In another embodiment of the present invention the wood chip board comprises one single layer only, i.e. a board without the first outer layer and second outer layer. Such a wood chip board is thus made by compressing a material comprising a mixture of glue, classified, dried wood material and particle foam polymer beads under pressure and heat to form said wood chip board. The process conditions for this embodiment are in agreement with the process conditions mentioned above for the present “sandwich” construction. Such a wood chip board contains predominantly wood material, glue and particle polymer beads and usual additives, if necessary, as mentioned above. In other words, in such an embodiment of the wood chip board no wood material based first outer layer and second outer layer are present.

The following example illustrates the present invention in more detail.

The process for preparing a wood chip board was as follows.

The wood (main raw material) was collected in bulk and reduced in size by blade grinder in order to reach 70-100 mm size. Air cleaning was used to eliminate impurities like: stone, glass, and metal. In the next step the particle size of wood was reduced to the desired values by using a hammer grinder. At the beginning of this step the moisture content was in the range of 25-30%. This value was reduced to 2-3% by a drum drier.

A particles size separation of the dried wood raw material was carried out. The bigger sized particles were used in the core layer in order to ensure the mechanical property (EN 312 particleboard requirements); the thinner sized particles were used in the surfaces layer in order to ensure adequate surface smoothness properties for the melamine paper lamination.

Both particle partitions have been separately mixed in a blender with a resin, namely urea formaldehyde resin, and additives, such as a wax for reducing the swelling power, a catalyst, such as ammonium sulphate, an additional amount of water for obtaining an adequate moisture level in the surface layer, urea powder for reducing the formaldehyde content and emission.

In a first composition stage a low density mattress in an endless shape has been formed and transported by a conveyer belt.

The mattress was formed from the bottom upwards: thin and small wood particles in the bottom (BL) surface layer; larger particles in the core layer (CL); thin particles in the top surface layer (SL).

After the mattress forming stage the process was followed by cold pressing to consolidate the mattress to a plate and then followed by a hot press stage to produce a self-supporting plate. Pressures are typical at 50-100 bars under an elevated temperature. The press plate is heated to 230° C.; and as a result the maximum internal board temperature is 105° C. In these conditions the resin cures and the final chip board is obtained.

In the last phase a smooth thickness can be reached by sanding. The particle board thus obtained was sawn and packed in stacks. These plates could be introduced on the market as such (raw board) or laminated by applying e.g. a melamine decorative sheet.

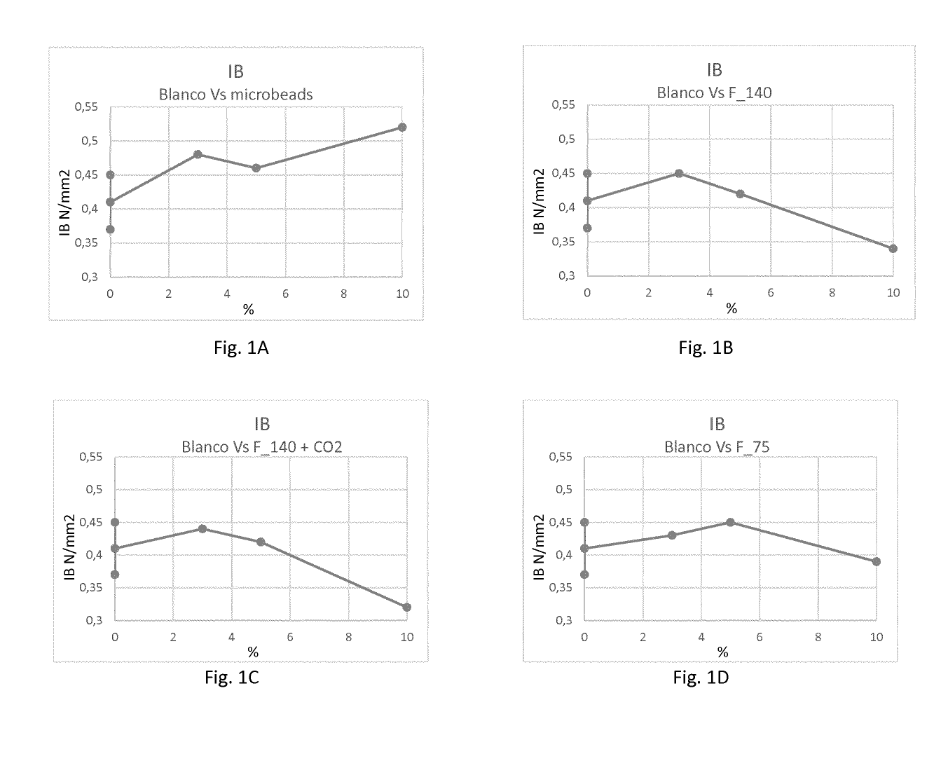

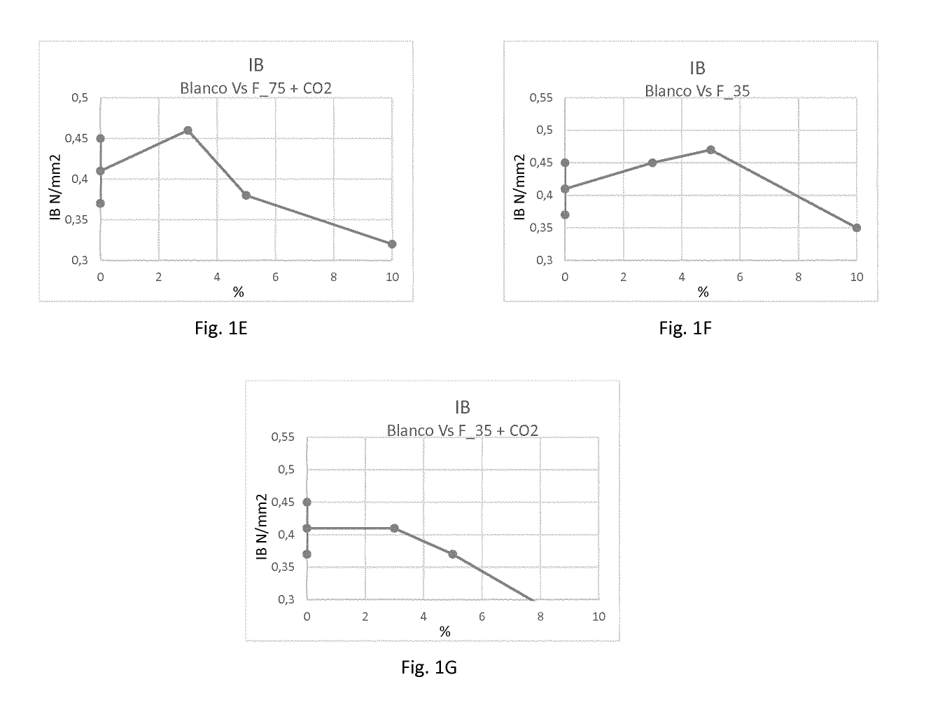

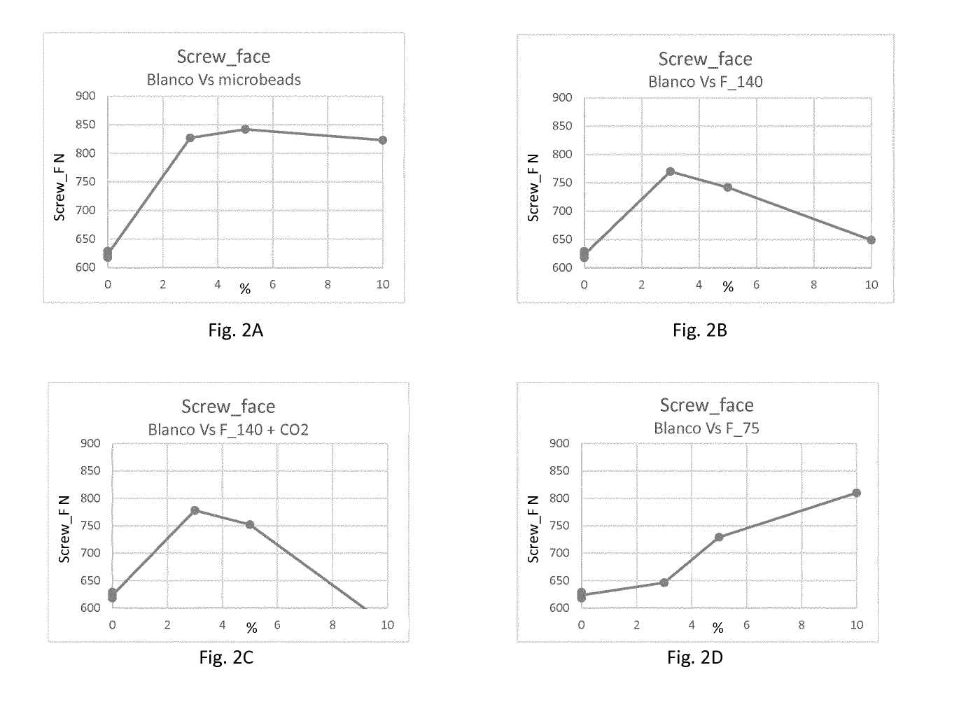

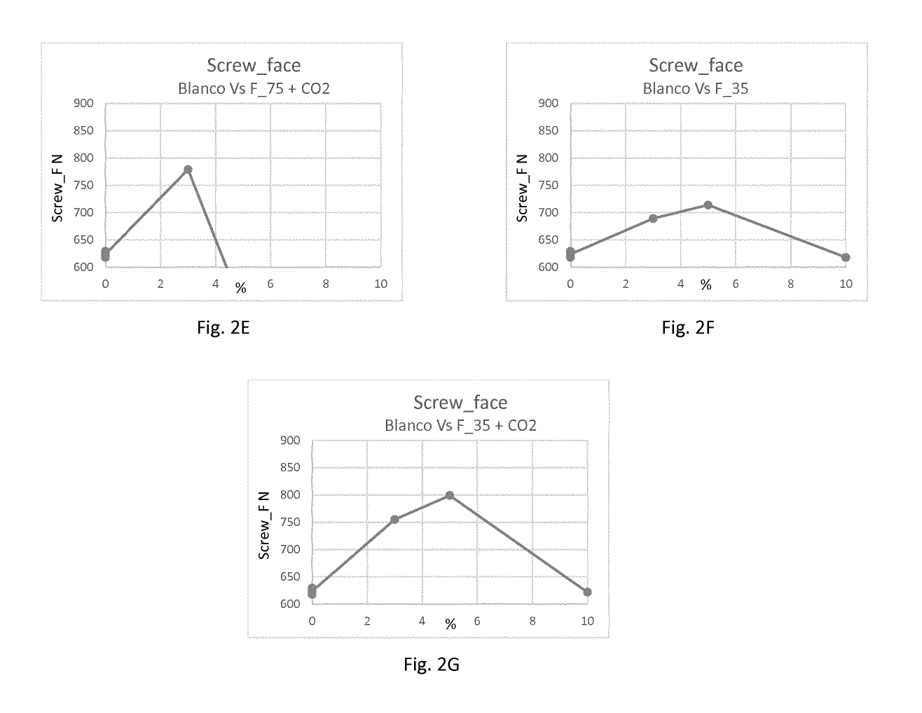

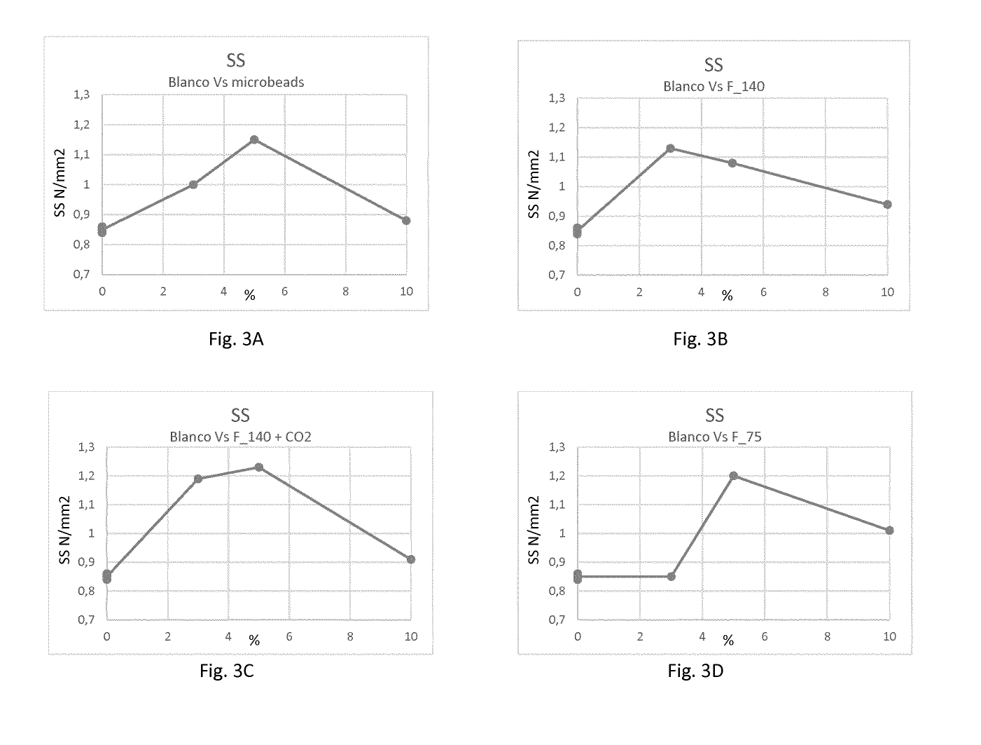

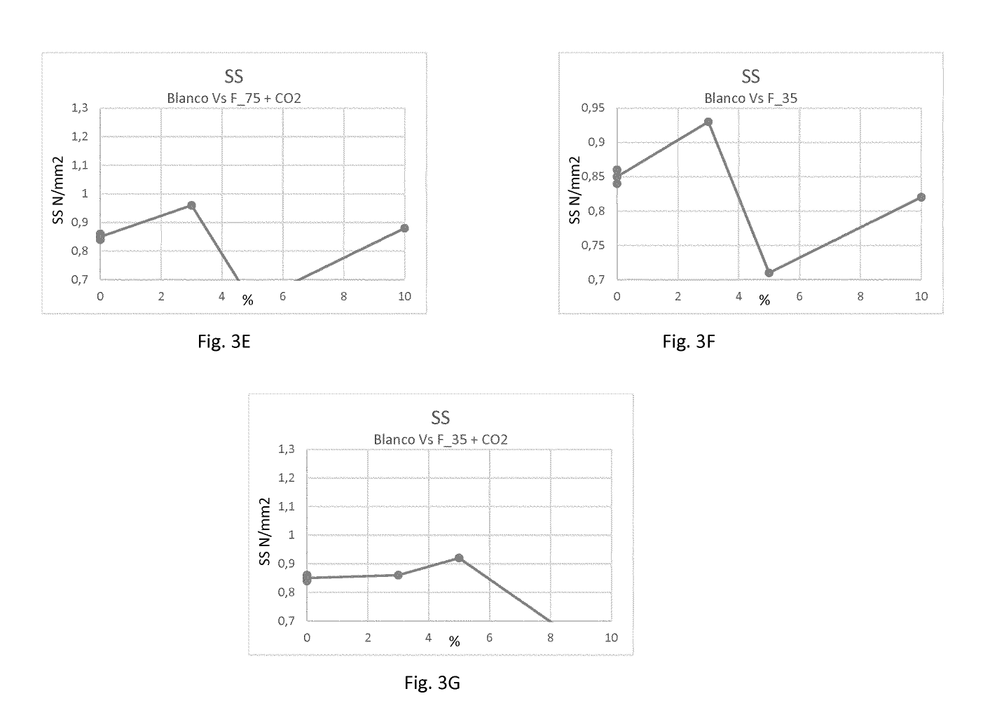

FIGS. 1A-1G relates to internal bonding for different types of panels, i.e. the IB (N/mm²) vs. % BioFoam. FIGS. 2A-2G relate to screw face (N) for different types of panels, i.e. the screw face (N) vs. % BioFoam. FIGS. 3A-3G relates to surface strength (SS) for different types of panels, i.e. the SS (N/mm2) vs. % BioFoam. These Figures are based on the experimental results of the additional examples (see below).

### EXAMPLE 1

A standard particle board having a bottom layer, core layer and surface layer was prepared according to the method disclosed above resulting in a density of 670 kg/m³.

### EXAMPLE 2

The Example 1 was repeated except for the core layer. Polylactic micro beads (PLA) made by Synbra of 1.0-1.6 mm diameter were impregnated with CO₂ of 20 bar and expanded in a pre-expander to become E-PLA with a density of 30 kg/m³. These expanded PLA beads were mixed with a mechanical mixer to become a homogenous part of the core layer. The composition of both the surface layer and the bottom layer were according to Example 1.

The wood chip board so obtained had a density of 610 kg/m³.

### EXAMPLE 3

A one off lab experiment with a PBAT/PLA expandable bead with a diameter of 1.5 mm with 6% pentane present as a blowing agent was added with a weight of 3% mixed in the central wood mixture and was found to not show a discernible difference from the properties of a reference sample. As it contains pentane it was deemed to be less suitable anyhow, as it may present safety issues in handling in the plant.

### ADDITIONAL EXAMPLES

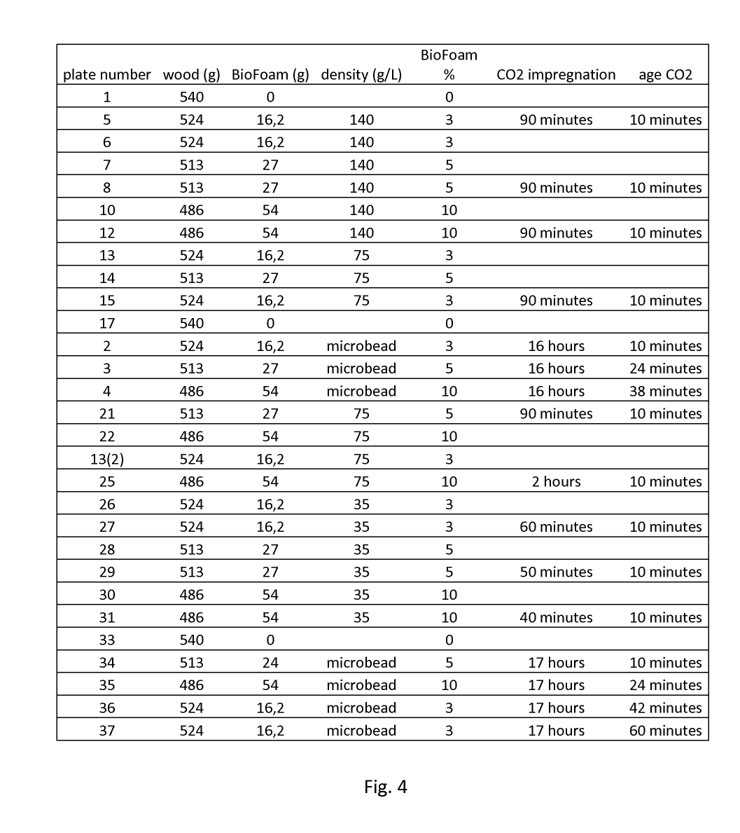

Additional examples of the present wood chip board have been manufactured according to the method disclosed above. The composition of the panels (indicated by plate numbers) have been summarized in the Table (see the enclosed FIG. 4). The Table especially refers to the composition of the core layer, namely the amount of wood (g), the amount of Bio-Foam (polylactic acid beads), density (g/l), wt. % BioFoam in core layer, CO₂ impregnation conditions (time), and CO₂ aging (time).

The results of these experiments have been shown in the FIGS. 1A-1G (internal bonding, IB), 2A-2G (screw face) and, 3A-3G (surface strength, SS).

The test for internal bonding (IB) is a tensile strength test for measuring the inner layer. A block to be tested is glued at both sides to a sample piece and positioned in a tensile testing machine.

The screw face test refers to test wherein a screw is screwed in a wood chip board. A force is applied on the screw and the force for withdrawing the screw from the board is measured.

The test for measuring the surface strength (SS) refers to the force needed for detaching the outer layer from the core layer. In that context a small round button is glued on the surface of the layer. The whole assembly is positioned in a tensile testing machine and the force for withdrawing the button from the surface is measured.

The FIGS. 1A, 2A and 3A disclose the effect of the use of microbeads compared to a blanc, i.e. a core layer without any particle foam polymer beads. The FIGS. 1B, 2B and 3B relate to BioFoam having a density of 140 g/l. The FIGS. 10, 2C and 3C relate to BioFoam having a density of 140 g/l and impregnation with CO₂. The FIGS. 1D, 2D and 3D relate to BioFoam having a density of 75 g/l. The FIGS. 1E, 2E and 3E relate to BioFoam having a density of 75 g/l and impregnation with CO₂. The FIGS. 1F, 2F and 3F relate to BioFoam having a density of 35 g/l. The FIGS. 1G, 2G and 3G relate to BioFoam having a density of 35 g/l and impregnation with CO₂.

From the experimental results one can learn that for the internal bonding (IB) the amount of BioFoam is within a range of 1-8 wt. %, preferably in a range of 2-6 wt. %, more preferably in a range of 3-5 wt. %. The experimental results with regard to screw face and surface strength show a similar result.

The BioBeads used here are either 1.0-1.6 of 0.7-1.0 mm type Synterra type BF2004 (BioFoam) with a D content of 4% and a Molecular weight Mw van 200 kDa, relative to polystyrene.

The expanded BioFoam (E-PLA) was made from Biobeads Synterra type BF2005 0.7-1.0 mm with a D content of 5% with a molecular weight of 200 kDa (relative to polystyrene) and expanded to the indicated densities by using CO₂ impregnation and expansion in a pre-expander.

There is no pointer in the prior art about the preferred range for the amount of particle foam polymer beads in a wood chip board comprising a core layer comprising particle foam polymer beads.

The present inventors wanted to manufacture a recycled wood particle board with a density of about 550 kg/m³ with the strength and properties of a recycled wood particle board of about 680 kg/m³. To achieve this density a reduction of the amount of wood in the core layer has been applied according to the present invention. The outside fine wood layers are kept the same. To achieve a somewhat similar strength as the heavy board a foam will be added according to the present invention. First trails were done on a lab scale. The test panel had a dimension of 300×300×18 mm. Internal bonding (IB) and screw face test (SF) are important factors to test the core layer of the final plate. A first set of tests was done with adding foamed beads to the core layer in different densities, 30-140 g/L. Secondly adding impregnated foamed beads in the same density range and impregnated Biobeads. Concentration ranges from 3% to 10% wt %. The addition of the 3% Biobeads showed the most interesting result on performance as well on cost. An additional set of tests was carried out to narrow the concentration of impregnated Biobeads and see the 1-3% range. Also included in the test was a difference between bead size. Sizes in the range of 0.7-1.0 mm and 1.0-1.6 mm Biobead fraction were tested. The 1.0-1.6 mm range showed a slight advantage. A third test was to see if the impregnation could be done at the premises of Synbra Technology (NL) and the impregnated Biobeads could be shipped on dry ice and foamed in the lab trails. Same results were measured with the transported beads as with the impregnated beads on site of Synbra Technology.

1. A process for preparing a wood chip board comprising drying a cut raw material, classifying the dried material into several portions, gluing at least one of said portions with a resin and compressing the chip material under pressure and heat to form a board, characterized in that the method comprises the following steps:
i) providing a first outer layer comprising a mixture of glue and classified, dried wood material;
ii) providing a core layer comprising a mixture of glue, classified, dried wood material and a particle foam polymer beads;
iii) providing a second outer layer comprising a mixture of glue and classified, dried wood material;
iv) forming a composite plate, comprising said first outer layer, said core layer and said second outer layer;
v) compressing said composite plate under pressure and heat to form said wood chip board.

2. A process according to claim 1, wherein step v) comprises two individual steps, namely a first compressing step va) wherein said composite plate is compressed at ambient temperature and a pressure in the range of 0.5-0.7 N/mm², followed by a second compressing step vb) wherein said composite plate is compressed in a temperature range of 200-250° C. and a pressure in the range of 1-5 N/mm².

3. A process according to any one of the preceding claims, wherein the amount of particle foam polymer beads in said mixture for the core layer is in a range of 1-50% by weight, preferably 3-50% by weight, more preferably 5-35% by weight, on basis of the total weight of said mixture for the core layer.

4. A process according to any one of the preceding claims, wherein the wood chip board obtained after step v) is provided with a decorative sheet.

5. A process according to any one of the preceding claims, wherein said polymer beads are particle foam polymer beads chosen form the group of polystyrene (PS), polystyrene-(poly(p-fenylene oxide) (PS/PPO), polypropylene (PP), polyethylene (PE), polyethylene terephthalate (PET), polylactic acid (PLA), mixtures of polylactic acid and starch (PLA/starch), poly(butylene adipate-co-terephthalate)-polylactic acid (PLA/PBAT), polylactic acid-polyhydroxyalkanoate (PLA/PHA), starch, polybutylene succinate (PBS) granulates of cellulose acetate butyrate (CAB), and resol, or combinations thereof.

6. A process according to claim 5, wherein in the poly(butylene adipate-co-terephthalate)-polylactic acid (PLA/PBAT) the amount of PBAT is in a range of 5-95 wt. %, preferably 15-85 wt. %, on basis of the total amount of poly(butylene adipate-co-terephthalate)-polylactic acid (PLA/PBAT).

7. A process according to claim any one of claims 5-6, wherein polylactic acid (PLA) is a copolymer of PLA and another biobased monomer, such as polyethylene glycol (PEG), poly(lactic-co-glycolic acid) (PLGA) and poly(ϵ-caprolactone) (PCL).

8. A process according to claim 7, wherein said copolymer is chosen from the group of poly(d,l-lactide) with poly(ethylene glycol) with hydroxyl end, poly(d,l-lactide) with poly(ethylene glycol) with carboxylic acid end, poly(d,l-lactide) with poly(ethylene glycol) with maleimide end, poly(d,l-lactide) with poly(ethylene glycol) with amine end, poly(lactide/glycolide) with poly(ethylene glycol) with —COOH end, poly(lactide/glycolide) with poly(ethylene glycol) with maleimide end and poly(lactide/glycolide) with poly(ethylene glycol) with amine end.

9. A process according to any one of the preceding claims, wherein polymer beads having a density in a range of 5-250 kg/m³, preferably 10-100 kg/m³, more preferably 20-40 kg/m³ are used.

10. A process according to any one of the preceding claims, wherein in step ii) polymer beads of the type unexpanded polymer beads loaded with a blowing agent are used.

11. A process according to claim 10, wherein as a blowing agent CO₂ is used.

12. A process according to any one of the claims 1-11, wherein polymer beads having a particle size chosen in a range of the group 2.0-1.6 mm, 1.0-1.6 mm, 0.7-1.0 mm or 0.7-0.4 mm, or a combination thereof are used.

13. A process according to any one of the claims 5-12, wherein the amount of particle foam polymer beads based on polylactic acid (PLA) in said mixture for the core layer is in a range of 1-8 wt. %, preferably in a range of 2-6 wt. %, more preferably in a range of 3-5 wt. %, on basis of the total weight of said mixture for the core layer.

14. A wood chip board provided with a core layer based on particle foam polymer beads, sandwiched between a first outer layer and a second outer layer, wherein both said first and second outer layer are based on wood material, wherein the amount of particle foam polymer beads based on polylactic acid (PLA) in said core layer is in a range of 1-8 wt. %, preferably in a range of 2-6 wt. %, more preferably in a range of 3-5 wt. %, on basis of the total weight of the core layer.

15. A wood chip board according to claim 14, wherein the density of the core layer is 660-500 kg/m³, preferably 600-550 kg/m³, more preferably 570-580 kg/m³.

16. A wood chip board according to any one or more of claims 14-15, wherein no wood material based first outer layer and second outer layer are present.

17. The use of a wood chip board according to any one or more of the claims 14-16 in construction panels, furniture, kitchen cupboards, tables and/or composites.
